(19) United States
(12) Patent Application Publication
(10) Pub. No.: US 2002/0076054 A1
(43) Pub. Date: Jun. 20, 2002

(54) Session shared key sharing method, wireless terminal authentication method, wireless terminal, and base station device

(75) Inventors: Shoji Fukutomi, Tokyo (JP); Masataka Ohta, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 09/996,923

(22) Filed: Nov. 30, 2001

(30) Foreign Application Priority Data
Dec. 14, 2000 (JP) 2000-381042
May 9, 2001 (JP) 2001-139288

(51) Int. Cl. H04K 1/00

(52) U.S. Cl. 380/277; 380/270; 380/30

(57) ABSTRACT

A public key used for creating a session shared key is inserted into a packet transmitted by a wireless terminal to an access point based on a DHCP. A public key used for creating the session shared key is inserted into a packet transmitted by the access point to the wireless terminal based on the DHCP. The access point creates the session shared key based on the public key and the wireless terminal creates the session shared key based on the public key. As a result, it becomes possible to safely share the session shared key K for privacy and/or authentication between the wireless terminal and the access point.

### FIELD OF THE INVENTION

The present invention relates to a session shared key sharing method in a wireless communication network system in which a wireless terminal and a base station device hold communication over the wireless in the same data link layer, a wireless terminal authentication method, a wireless terminal and a base station device. “In the same data link layer” means herein in a range in which communication can be established without using a router.

### BACKGROUND OF THE INVENTION

Conventionally, a wireless LAN system standardized as IEEE802.11 is known. This wireless LAN system employs, as an access system, aCSMA/CA (Carrier Sense Multiple Access with Collision Avoidance) system. In this wireless LAN system, specific procedures for key exchange used for authentication to start communication are not specified and each wireless terminal can basically, freely access the network.

### SUMMARY OF THE INVENTION

It is one object of the present invention to safely share a session shared key for privacy and/or authentication between a wireless terminal and a base station device while suppressing the delay of the establishment of the communication between the wireless terminal and the base station device.

It is an another object of the present invention to decrease illegal access to the network while suppressing the delay of the establishment of the communication between a wireless terminal and a wireless station device.

The session shared key sharing method according to one aspect of the present invention is a method of sharing a session shared key for privacy and/or authentication between a wireless terminal for transmitting and receiving a packet and a base station device for relaying the packet when the wireless terminal and the base station device communicate with each other over wireless. This method includes: a first insertion step of inserting first information used for creating the session shared key into the packet transmitted from the wireless terminal to the base station device based on a protocol executed when the wireless terminal and the base station device start communicating with each other; a second insertion step of inserting second information used for creating the session shared key into the packet transmitted from the base station device to the wireless terminal based on the protocol; a first creation step of allowing the base station device to create the session shared key based on the first information inserted in the first insertion step; and a second creation step of allowing the wireless terminal side to create the session shared key based on the second information inserted in the second insertion step.

The wireless terminal authentication method according to another aspect of the present invention is a method of authenticating a wireless terminal for transmitting and receiving a packet by a base station device for relaying the packet when the wireless terminal and the base station device communicate with each other over wireless, which method includes: an encryption step of enciphering first information for creating a session shared key used for the authentication using a secret key; a first insertion step of inserting the first information enciphered in the encryption step into the packet transmitted from the wireless terminal to the base station device based on a protocol executed when the wireless terminal and the base station device start communicating with each other; a decoding step of allowing the base station device to transmit the enciphered first information inserted in the first insertion step to an authentication station decoding and resending information enciphered using the secret key, and to receive the first information decoded by the authentication station; a second insertion step of inserting second information used for creating the session shared key into the packet transmitted from the base station device to the wireless terminal based on the protocol; a first creation step of allowing the base station device to create the session shared key based on the first information decoded in the decoding step; and a second creation step of allowing the wireless terminal to create the session shared key based on the second information inserted in the second insertion step.

The wireless terminal according to the still another aspect of the present invention communicates with a base station device that relays a packet over wireless. This wireless terminal comprises: an insertion unit which inserts first information used for creating a session shared key for privacy and/or authentication into the packet transmitted to the base station device based on a protocol executed when the wireless terminal starts communicating with the base station device; an acquisition unit which acquires second information included in the packet transmitted from the base station device based on the protocol and used for creating the session shared key; and a creation unit which creates the session shared key based on the second information acquired by the acquisition unit.

The wireless terminal according to the still another aspect of the present invention communicates with a base station device that relays a packet over wireless. This wireless terminal comprises: an encryption unit which enciphers first information used for creating a session shared key for authenticating the wireless terminal using a secret key; an insertion unit which inserts the first information enciphered by the encryption unit into the packet transmitted to the base station device based on a protocol executed when the wireless terminal starts communicating with the base station device; an acquisition unit which acquires second information included in the packet transmitted from the base station device based on the protocol and used for creating the session shared key; and a creation unit which creates the session shared key based on the second information acquired by the acquisition unit.

The base station device according to still another aspect of the present invention relays a packet and the packet is transmitted and received by a wireless terminal. This base station device comprises: an acquisition unit which acquires first information included in the packet transmitted from the wireless terminal based on a protocol executed when the base station device starts communicating with the wireless terminal, the first information used for creating a session shared key for privacy and/or authentication; an insertion unit which inserts second information used for creating the session shared key into the packet transmitted to the wireless terminal based on the protocol; and a creation unit which creates the session shared key based on the first information acquired by the acquisition unit.

The base station device according to still another aspect of the present invention relays a packet and the packet is transmitted and received by a wireless terminal. This base station device comprises: an acquisition unit which acquires first information included in a packet transmitted from the wireless terminal based on a protocol executed when the base station device starts communicating with the wireless terminal, the first information enciphered by a secret key and used for creating a session shared key for authenticating the wireless terminal; a decoding unit which transmits the enciphered first information acquired by the acquisition unit to an authentication station decoding and resending information enciphered by the secret key, and for receiving the first information decoded by the authentication station; an insertion unit which inserts second information used for creating the session shared key into the packet transmitted to the wireless terminal based on the protocol; and a creation unit which creates the session shared key based on the first information received by the decoding unit.

Other objects and features of this invention will become apparent from the following description with reference to the accompanying drawings.

### BRIEF DESCRIPTION OF THE DRAWINGS

FIG. 1 is an explanatory view showing the configuration of a communication network system in one embodiment according to the present invention;

FIG. 2 is a block diagram showing the schematic configuration of a wireless terminal shown in FIG. 1;

FIG. 3 is a block diagram showing the schematic configuration of an access point shown in FIG. 1;

FIG. 4 is a block diagram showing the schematic configuration of an authentication server shown in FIG. 1;

FIG. 5 is an explanatory view showing processing procedures for a session shared key creation processing in this embodiment;

FIG. 6 is an explanatory view showing processing procedures for a session shared key creation processing when a roaming service is used in this embodiment;

FIG. 7 is an explanatory view showing processing procedures for an MAC frame creation processing in this embodiment;

FIG. 8 is an explanatory view showing processing procedures for an authentication processing in this embodiment; and

FIG. 9 is an explanatory view for describing a privacy processing in this embodiment.

### DETAILED DESCRIPTIONS

The present invention has been achieved in order to solve the following problems.

According to the conventional technique, a wireless terminal communicates with a base station device wirelessly. However, the wireless communication can be tapping easily by a third party and the third party can easily make illegal communication because, generally, privacy protection and/or authentication of the wireless terminal (“wireless terminal side”) and the base station device (“base station device side”) based on session shared key etc. are not performed. As a result, the conventional technique has a disadvantage in that a session shared key for privacy and/or authentication cannot be safely shared between the wireless terminal and the base station device.

In addition, according to the conventional technique, a wireless terminal side communicates with a base station device side over the wireless over which the wire tapping and transmission of a communication can be easily made by an illegal third party and no procedures for authenticating a wireless terminal to be connected to a network are specified. Due to this, the above-stated technique has a disadvantage of involving a high risk of illegal access to the network. Furthermore, when communication is held using a wireless terminal requiring hand over and having a high probability of packet missing and the number of times of packet exchange is increased at the start of the communication between the wireless terminal and a base station device, then delay becomes disadvantageously longer until the establishment of the communication.

Embodiment of the present invention will be described hereinafter in detail with reference to the accompanying drawings. It should be is noted that the present invention is not limited to this embodiment.

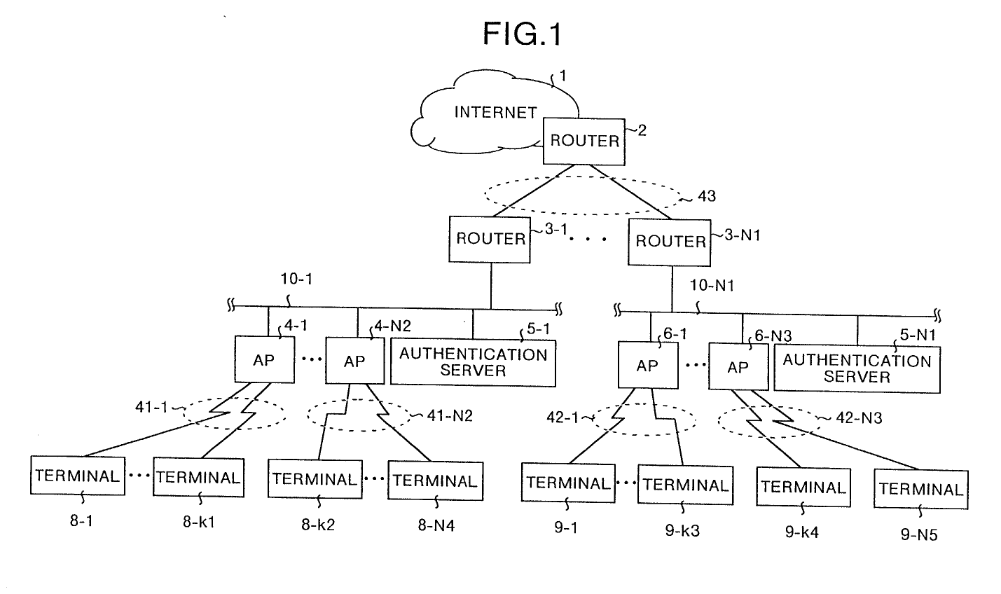

FIG. 1 is an explanatory view showing the configuration of a communication network system in one embodiment according to the present invention. This communication network system includes a backbone network 43, a router 2 connecting the backbone network 43 to the Internet 1, global LAN's 10-1 to 10-N1 for respective business companies, and routers 3-1 to 3-N1 connecting the global LAN's 10-1 to 10-N1 to the backbone network 43, respectively. At least one base station (access point) is connected to each of the global LAN's 10-1 to 10-N1. In this embodiment, access points 4-1 to 4-N2 are connected to the global LAN 10-1 and access points 6-1 to 6-N3 are connected to the global LAN 10-N1.

Each access point is connected to wireless terminals over the wireless to form a wireless network. In this embodiment, the access point 4-1 is connected to wireless terminals 8-1 to 8-k1 and forms a wireless network 41-1. The access point 4-N2 is connected to wireless terminals 8-k2 to 8-N4 and forms a wireless network 41-N2. The access point 6-1 is connected to wireless terminals 9-1 to 9-k3 and forms a wireless network 42-1. The access point 6-N3 is connected to wireless terminals 9-k4 to 9-N5 and forms a wireless network 42-N3. Each wireless terminal can communicate with the Internet and the other wireless terminals through the respective access points.

Further, authentication servers 5-1 to 5-N1 holding authentication data on wireless terminals are connected to the global LAN's 10-1 to 10-N1, respectively. The authentication servers 5-1 to 5-N1 can hold reliable communication with the respective access points. The user of each wireless terminal concluded a contract with any one of the business companies for the use of the network of the business company. The authentication servers 5-1 to 5-N1 hold authentication data for authenticating the wireless terminals of the users (to be referred to as “contract users” hereinafter) who contracted with the business companies having their own authentication servers (which business companies will be referred to as “own business companies” hereinafter), respectively. The authentication data unit herein each user's ID and a secret key shared with the user.

That is to say, the secret key is shared between an authentication station and a wireless terminal in advance. It is noted that the key unit information for enciphering and/or decoding information. Alternatively, the routers 2 and 3-1 to 3-N1 may be replaced by bridges, respectively. Also, the authentication servers 5-1 to 5-N1 may not be necessarily connected directly to the global LAN's 10-1 to 10-N1, respectively. For example, the authentication servers 5-1 to 5-N1 may be connected to the Internet 1 or the like and then connected to the global LAN's 10-1 to 10-N1 through the routers 3-1 to 3-N1, respectively.

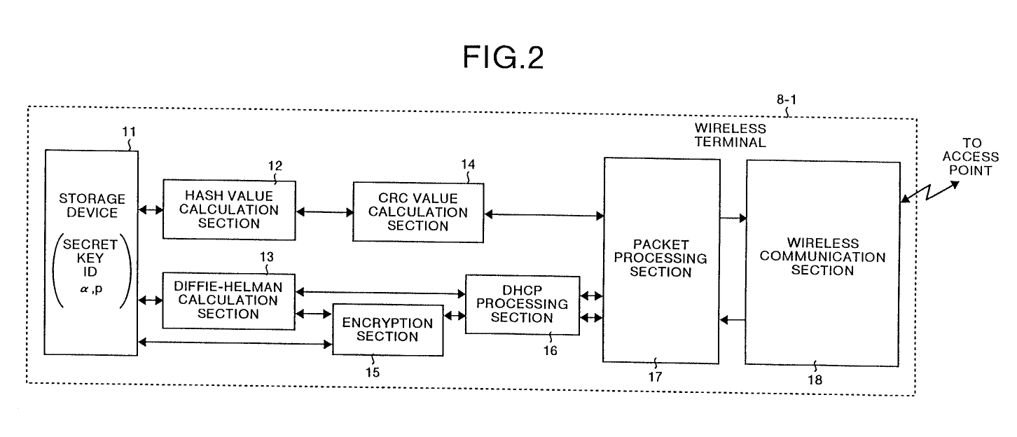

Next, the configuration of each wireless terminal will be described. FIG. 2 is a block diagram showing the schematic configuration of the wireless terminal 8-1 shown in FIG. 1. The wireless terminal 8-1 includes a storage device 11 holding a user's ID, a secret key as well as information on a prime p and a primitive root α used for Diffie-Helman type open key delivery method, a Diffie-Helman calculation section 13 creating a public key Y_{A} using the prime p and the primitive root α based on the Diffie-Helman type public key delivery method, acquiring a public key Y_{B} from an access point, calculating a session shared key K and storing the calculated session shared key K in the storage device 11, and an encryption section 15 enciphering the public key Y_{A} created by the Diffie-Helman calculation section 13 using a secret key.

The wireless terminal 8-1 also includes a DHCP processing section 16 transmitting and receiving a packet based on a DHCP (Dynamic Host Configuration Protocol) when starting communication with the access point, a hash value calculation section 12 calculating a hash value based on data including the data link layer payload of a packet to be transmitted and the session shared key K, a CRC value calculation section 14 calculating a CRC value based on data including the data link layer payload and the MAC address of the packet to be transmitted and the hash value calculated by the hash value calculation section 12, a packet processing section 17 performing MAC frame transmission and receiving processings, and a wireless communication section 18 communicating with the access point over the wireless.

The prime p and the primitive root α are shared among the respective wireless terminals and the respective access points in advance. For example, “2” is used as the primitive root α and 768-bit or 1024-bit prime is used as the prime p. The storage device 11 includes a programmable nonvolatile recording medium such as an EEPROM or a RAM having a power backup and holds information on the ID, the secret key, the prime p and the primitive root α. The Diffie-Helman calculation section 13 selects an integer X_{A} between [0, p−1] at random based on the Diffie-Helman type public key delivery method, creates the public key Y_{A} using the information on the prime p and the primitive root α held by the storage device 11, acquires the public key Y_{B} from the access point, calculates the session shared key K using the integer X_{A} and the public key Y_{B}, and stores the calculated session shared key K in the storage device 11.

The encryption section 15 enciphers the public key Y_{A} created by the Diffie-Helman calculation section 13 using the secret key held by the storage device 11. The DHCP processing section 16 inserts the ID stored in the storage device 11 and the public key Y_{A} enciphered by the encryption section 15 (which enciphered public key Y_{A} will be denoted by “E(Y_{A})” hereinafter) into a predetermined packet such as DHCP-DISCOVER or DHCP-REQUEST transmitted based on the DHCP. The ID and E(Y_{A}) may be inserted into the MAC header of the packet or into the data link layer payload thereof. Also, the DHCP processing section l6 acquires a predetermined packet such as DHCP-OFFER or DHCP-ACK transmitted based on the DHCP from the access point, extracts the public key Y_{B} included in this packet and outputs the extracted public key Y_{B} to the Diffie-Helman calculation section 13.

The hash value calculation section 12 calculates a hash value based on data including the data link layer payload of the packet to be transmitted and the session shared key K held by the storage device 11. The CRC value calculation section 14 calculates a CRC value based on data including the data link layer payload of the packet to be transmitted, the MAC address thereof and the hash value calculated by the hash value calculation section 12. The packet processing section 17 creates and transmits an MAC frame from the data link layer payload, the MAC address and the CRC value calculated by the CRC calculation section 14 and receives an MAC frame from the access point.

The wireless communication section 18 communicates with the access point over the wireless. The wireless terminal 8-1 can access the access points 4-1 to 4-N2 of the business company with which the user of the wireless terminal 8-1 contracted. If using a roaming service, the enciphered public key E(Y_{A}) and ID are transmitted from the authentication server of a network to be accessed by the wireless terminal 8-1 to the authentication server 5-1 and the authentication server 5-1 sends back the decoded public key Y_{A}. The remaining wireless terminals are the same in configuration as the wireless terminal 8-1.

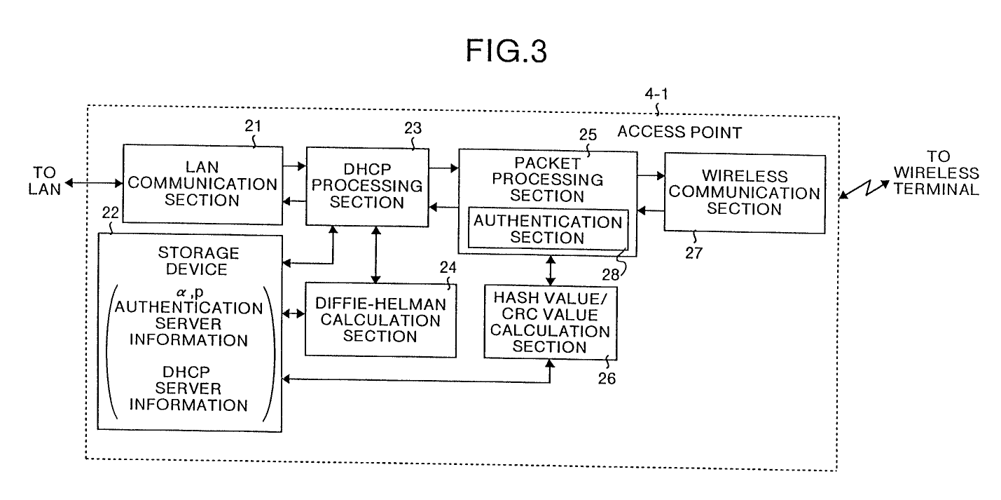

Next, the access point will be described. FIG. 3 is a block diagram showing the schematic configuration of the access point 4-1 shown in FIG. 1. The access point 4-1 includes a LAN communication section 21 communicating with the global LAN 10-1, a storage device 22 storing information on the prime p, the primitive root α, the address of the authentication server and the address of the DHCP server, and a Diffie-Helman calculation section 24 acquiring the public key Y_{A} from the wireless terminal based on the Diffie-Helman type public key delivery method, creating the public key Y_{B} using the prime p and the primitive root α, calculating the session shared key K and storing the session shared key K in the storage device 22.

The access point 4-1 also includes a DHCP processing section 23 detecting a predetermined packet based on the DHCP, extracting and inserting the public key based on the Diffie-Helman type public key delivery method, a hash value/CRC value calculation section 26 calculating a hash value based on data including the data link layer payload of the packet and the session shared key K from the wireless terminal, and calculating a CRC value based on data including the data link layer payload and the MAC address of this packet and the calculated hash value, a packet processing section 25 performing MAC frame transmission and receiving processings and authenticating the wireless terminal for each packet, and a wireless communication section 27 communicating with the wireless terminal over the wireless.

The LAN communication section 21 communicates with the global LAN 10-1. The storage device 22 includes a recording medium such as a hard disk or a RAM, and holds information on the prime p, the primitive root α, the address of the authentication server and the address of the DHCP server. The Diffie-Helman calculation section 24 acquires the public key Y_{A} from the wireless terminal based on the Diffie-Helman type public key delivery method, selects an integer X_{B} between [0, p−1] at random, creates the public key Y_{B} using the prime p and the primitive root α held by the storage device 22 as well as the integer X_{B}, calculates the session shared key K using the integer X_{B} and the public key Y_{B} and stores the session shared key K in the storage device 22.

The DHCP processing section 23 transfers the packet from the packet processing section 25 to the LAN communication section 21 and transfers the packet from the LAN communication section 21 to the packet processing section 25. Also, the DHCP processing section 23 checks packets to be transferred from the packet processing section 25 to the LAN communication section 21, detects a predetermined packet based on the DHCP and including information on the enciphered public key E(Y_{A}) and the ID, extracts the enciphered public key E(Y_{A}) and the ID included in this packet, transmits the extracted enciphered public key E(Y_{A}) and ID to the authentication server 5-1 to ask that the server 5-1 decodes the enciphered public key E(Y_{A}), and receives the decoded public key Y_{A} from the authentication server 5-1.

Further, the DHCP processing section 23 checks packets to be transferred from the LAN communication section 21 to the packet processing section 25, detects a predetermined packet based on the DHCP, inserts the public key Y_{B} calculated by the Diffie-Helman calculation section 24 into this packet and transfers the resultant packet to the packet processing section 25. The hash value/CRC value calculation section 26 calculates the hash value based on the data including the data link layer payload of the packet from the wireless terminal and the session shared key K held by the storage device 22 and calculates the CRC value based on the data including the data link layer payload and the MAC address of this packet and the calculated hash value.

The packet processing section 25 performs MAC frame transmission and receiving processings and authenticates the wireless terminal for each packet by an authentication section 28 built in the packet processing section 25. The authentication section 28 compares the CRC value of the packet from the wireless terminal with the CRC value calculated by the hash value/CRC value calculation section 26, and determines whether the access is legal or illegal based on whether or not the CRC values are coincident with each other. If the access is an illegal access, the authentication section 28 destroys the packet. Alternatively, in view of a data error due to communication disturbance, the authentication section 28 may issue a packet retransmission request. The wireless communication section 27 communicates with each wireless terminal over the wireless.

Since this embodiment shows an example in which the authentication server 5-1 also functions as the DHC server, the storage device 22 holds both information on the address of the authentication server 5-1 and that of the address of the DHCP server. In addition, the DHCP processing section 23 may transfer a predetermined packet based on the DCHP to the authentication server 5-1 as it is and the authentication server 5-1 may extract the enciphered public key E(Y_{A}) and the ID from this packet and transmit the decoded public key Y_{A} together with the predetermined packet based on the DHCP to the access point 4-1. The remaining access points are the same in configuration as the access point 4-1.

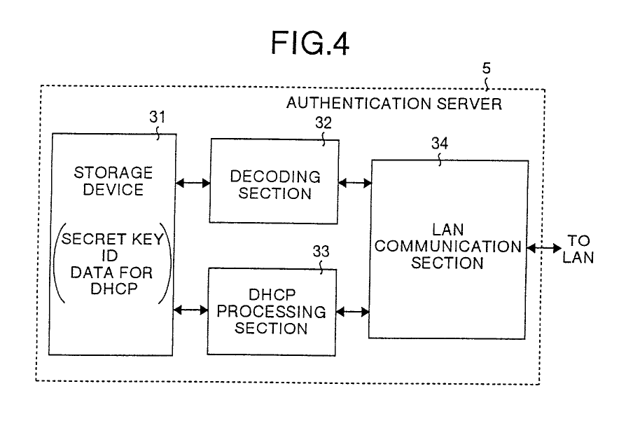

Next, the authentication server will be described. FIG. 4 is a block diagram showing the schematic configuration of the authentication server 5-1 show in FIG. 1. The authentication server 5-1 includes a storage device 31 holding information on the secret key and the ID of each contract user of the own business company and DHCP data, a decoding section 32 decoding and resending the enciphered public key E(Y_{A}) transmitted from the access point using the secret key in accordance with the ID transmitted from the access point, a DHCP processing section 33 performing DHCP transmission and receiving processings, and a LAN communication section 34 communicating with the global LAN 10-1.

The storage device 31 includes a recording medium such as a hard disk or a RAM, and holds information on the secret key and the ID of each contract user of the own business company and DHCP data. The decoding section 32 decodes the enciphered public key E(Y_{A}) transmitted from the access point, using the secret key in accordance with the ID transmitted from the access point, and resends the decoded public key Y_{A} to the access point which is the sender. If the ID transmitted from the access point is the ID of the other business company and a roaming service is available, then the decoding section 32 transmits the ID and the enciphered public key E(Y_{A}) to the authentication server of the other business company to ask that the enciphered public key E(Y_{A}) is decoded.

As can be seen, the decoding of the enciphered public key E(Y_{A}) is conducted only by the authentication server of the business company contracting with the user who enciphers the public key Y_{A}. Due to this, there is no need to give the secret key to the authentication server to be used during the roaming service or the access point involving a high risk that information is stolen. That is to say, it is possible to appropriately protect the secret key. The DHCP processing section 33 performs processings for receiving packets such as DHCP-DISCOVER and DHCP-REQUEST, transmitting packets such as DHCP-OFFER and DHCP-ACK and dynamically allocating an IP address to the wireless terminal. The LAN communication section 34 communicates with the global LAN 10-1.

While this embodiment shows an example in which the authentication server 5-1 also functions as the DHCP server, a DHCP server may be provided separately from the authentication server 5-1. Also, the respective access points 4-1 to 4-N2 may function as the DHCP servers. In the latter case, the DHCP processing section 23 of each of the access points 4-1 to 4-N2 executes the DHCP processing executed by the authentication server 5-1. The remaining authentication servers 5-2 to 5-N1 are the same in configuration as the authentication server 5-1.

Further, the respective constituent elements of the wireless terminal, the access point and the authentication server stated above are functionally conceptual and may not be necessarily, physically configured as shown in FIGS. 2 to 4. For example, all of or a part of the processing functions of the respective constituent elements can be realized by a CPU (Central Processing Unit) which is not shown and a program interpreted and realized by this CPU. Namely, an ROM, which is not shown, stores a computer program for issuing an instruction to the CPU in cooperation with an OS (Operating System) or the like to allow the CPU to perform various processings. The CPU performs the various processings in accordance with this program. It is also possible that all of or a part of the processing functions of the respective constituent elements are realized by a wired logic hardware.

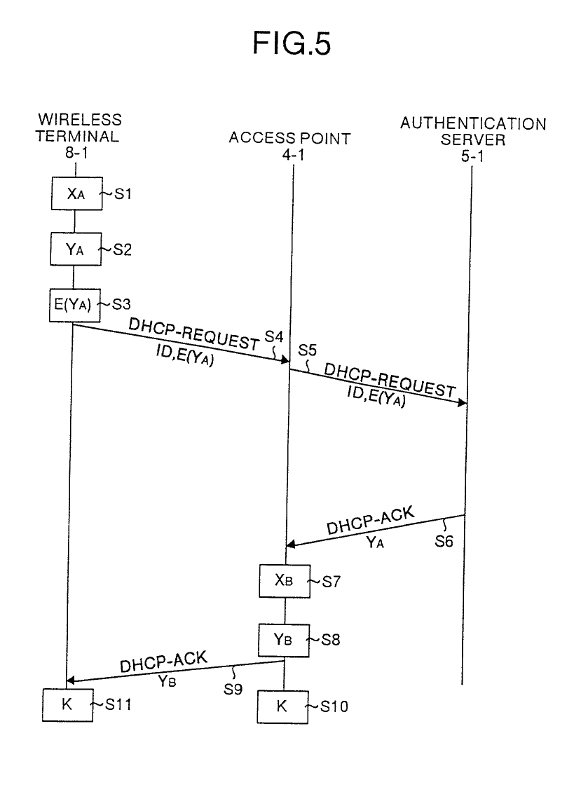

Next, the operation of this embodiment will be described with reference to FIGS. 5 to 9. FIG. 5 is an explanatory view showing processing procedures for a session shared key creation processing for creating the session shared key K prior to the establishment of the communication. Description will be given herein while taking a case where the wireless terminal 8-1 and the access point 4-1 create the session shared key K as an example. In this session shared key creation processing, the wireless terminal 8-1 first determines and stores the integer X_{A} (in step S1). Next, the wireless terminal 8-1 calculates the public key Y_{A} expressed by a formula 1 based on the prime p, the primitive root α and the integer X_{A} (in step S2).

Y_{A}=α(X_{A}) mod(p) (1)

In the formula 1, A mod(B) indicates a remainder of the division of integer A by integer B and A(B) indicates the B^{th} power of A.

Next, the wireless terminal 8-1 enciphers the calculated public key Y_{A} using the secret key and creates the enciphered public key E(Y_{A}) (in step S3), inserts the ID and the enciphered public key E(Y_{A}) into the DHCP-REQUEST and transmits the resultant packet to the access point 4-1 (in step S4) . When receiving the DHCP-REQUEST, the access point 4-1 transfers this DHCP-REQUEST, extracts the ID and the enciphered public key E(Y_{A}) included in this DHCP-REQUEST and transmits the ID and the enciphered public key E(Y_{A}) to the authentication server 5-1 to ask that the server 5-1 decodes the enciphered public key E(Y_{A}) (in step S5). When receiving the DHCP-REQUEST, the ID and the E(Y_{A}), the authentication server 5-1 decodes the enciphered public key E(Y_{A}) using the secret key corresponding to this ID, and resends the decoded public key Y_{A} together with the DHCP-ACK to the access point 4-1 (in step S6).

When receiving the DHCP-ACK and the public key Y_{A}, the access point 4-1 determines the integer X_{B} (in step S7). Next, the access point 4-1 calculates the public key Y_{B} expressed by a formula 2 based on the prime p, the primitive root α and the integer X_{B} (in step S8).

Y_{B}=α(X_{B}) mod(p) (2)

Next, the access point 4-1 inserts the public key Y_{B} into the DHCP-ACK and resends the resultant packet to the wireless terminal 8-1 (in step S9). Also, the access point 4-l calculates the session shared key K expressed by a formula 3 based on the public key Y_{A} and the integer X_{B} and stores the calculated session shared key K (n step S10).

K=Y_{A}(X_{B}) mod(p)=\hat{α}(X_{A}·X_{B}) mod(p) (3)

On the other hand, when receiving the DHCP-ACK, the wireless terminal 8-1 extracts the public key Y_{B} included in the DHC-ACK. The wireless terminal 8-1 calculates and stores the session shared key K expressed by a formula 4 based on the public key Y_{B} and the integer X_{A} (in step S11).

K=Y_{B}(X_{A}) mod(p)=\hat{α}(X_{A}·X_{B}) mod(p) (4)

Here, when the session shared key K is correctly shared between the access point 4-1 and the wireless terminal 8-1, it means that the wireless terminal 8-1 and the authentication server 5-1 share a secret key therebetween. Due to this, the access point 4-1 can authenticate the wireless terminal 8-1 as a legal wireless terminal. Conversely, when the session shared key K cannot be correctly shared between the access point 4-land the wireless terminal 8-1, it means that the wireless terminal 8-1 and the authentication server 5-1 do not share a secret key therebetween. Due to this, the access point 4-1 can authenticate the wireless terminal 8-1 as an illegal wireless terminal.

As can be seen, by combining the exchange of the public keys Y_{A} and Y_{B} for creating the session shared key K with the DHCP, it is possible to share the session shared key K between the access point 4-1 and the wireless terminal 8-1 without increasing the number of times of packet exchange and to thereby ensure efficient communication. In addition, when the wireless terminal 8-1 starts communication, when hand over is performed, and when communication is broken off and a communication start processing is performed again, then it is possible to prevent the increase of delay time until the establishment of communication. The session shared key K shared between the wireless terminal 8-1 and the access point 4-1 can be used for various privacy and/or authentication in the communication between the wireless terminal 8-1 and the access point 4-1. In this embodiment, a session shared key is created every time hand over is performed. Alternatively, a handed-over access point may acquire the IP and the session shared key of the wireless terminal from the original access point.

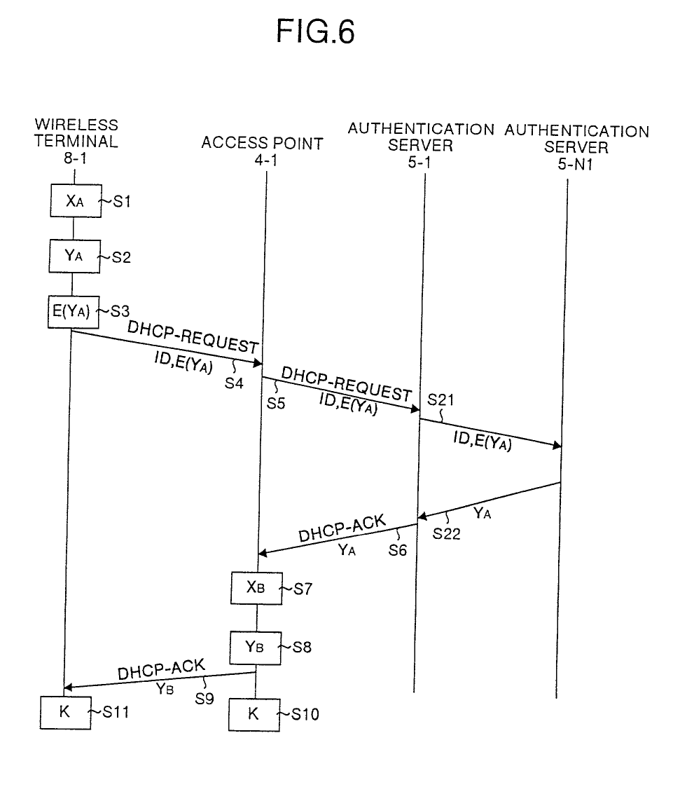

Next, description will be given to a case of performing roaming. FIG. 6 is an explanatory view showing processing procedures for a session shared key creation processing when a roaming service is used in this embodiment. Here, description will be given while taking a case where the wireless terminal 9-1 and the access point 4-1 create the session shared key K as an example. It is noted that the same processing steps as those in a case where roaming is not performed are denoted by the same reference symbols as those in FIG. 5. In this session shared key creation processing, the authentication server 5-1 determines that the ID received in the step S5 is not the ID of the own business company, and transmits this ID and the enciphered public key E(Y_{A}) to the authentication server 5-N1 of the business company corresponding to the received ID to ask that the enciphered public key E(Y_{A}) is decoded (in step S21).

When receiving the ID and the enciphered public key E(Y_{A}) from the authentication server 5-1, the authentication server 5-N1 decodes the enciphered public key E(Y_{A}) using a secret key corresponding to this ID and resends the decoded public key Y_{A} to the authentication server 5-1 (in step S22) The authentication server 5-1 receives the public key Y_{A} from the authentication server 5-N1 and transfers the public key Y_{A} to the access point 4-1. Alternatively, the authentication server 5-1N may transmit the public key Y_{A} to the access point 4-1. In this way, even when roaming is performed, the session shared key K can be shared without letting the access point 4-1 and the authentication server 5-1 know the secret key.

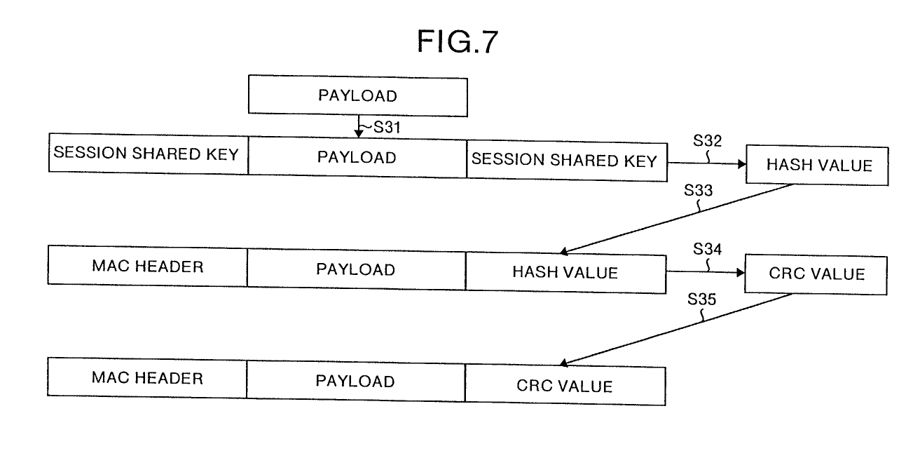

Next, a wireless terminal authentication processing by the access point after completing the DHCP and session shared key creation processings will be described. In this authentication processing, the hash value is generated using the session shared key K, the hash value is added to the CRC value of the MAC frame and thereby authentication is conducted to the wireless terminal for each packet. FIG. 7 is an explanatory view showing processing procedures for a MAC frame creation processing by the wireless terminal in this embodiment. In this MAC frame creation processing, the wireless terminal first creates data including the data link layer payload of a packet to be transmitted and the session shared key K (in step S31).

In this embodiment, the data having the data link layer payload put between the session shared key K. The arrangement order of the data link layer payload and the session shared key K is not limited to a specific one. The session shared key K may be added to one side of the data link layer payload or the session shared key maybe put between the data link layer payload. It is also possible to use only a part of the session shared key K and the data link layer payload. Further, the MAC header may be included in this data. Next, the wireless terminal calculates the hash value from the data generated in the step S31 (in step S32).

Thereafter, the wireless terminal creates data including the calculated hash value, the MAC header and the data link layer payload of the packet to be transmitted (in step S33) The arrangement order of this data is not limited to a specific one, either. The wireless terminal calculates the CRC value of the data created in the step S33 (in step S34), uses this CRC value as the CRC value of the MAC frame (in step S35) and transmits this MAC frame to the access point.

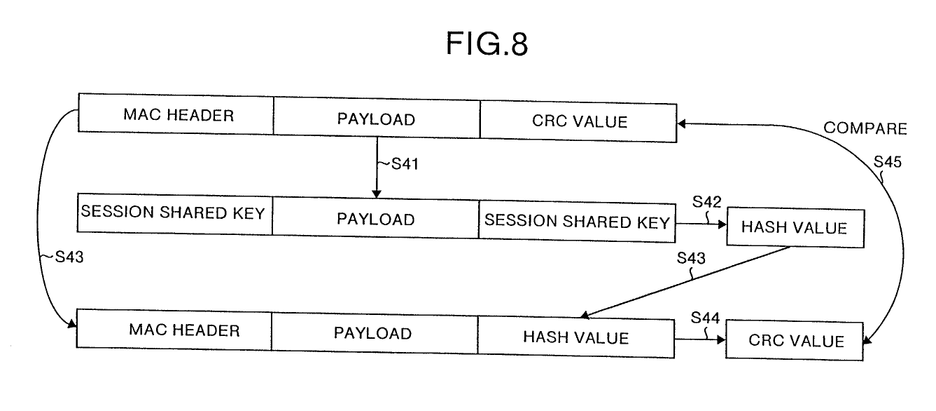

FIG. 8 is an explanatory view showing processing procedures for an authentication processing for each packet by the access point in this embodiment. In this authentication processing, the access point first creates data including the data link layer payload of the packet received from the wireless terminal and the session shared key K by the same method as that of the wireless terminal stated above (in step S41). Next, the access point calculates the hash value form this data (in step S42). Next, the access point creates data including the calculated hash value and the MAC header and the data link layer payload of the received packet by the same method as that of the wireless terminal stated above (in step S43).

The access point calculates the CRC value of the data created in the step S43 (in step S44), and compares this CRC value with the CRC value of the received packet. If these CRC values are the same, the access point determines that the wireless terminal has a correct secret key shared between the wireless terminal and the authentication server and the wireless terminal is authenticated as a legal wireless terminal. As can be seen, it is possible to perform authentication for each packet without changing a packet format. Thus, this authentication processing has no influence on the maximum transferable data length of the data link and is transparent to users.

Furthermore, this method is also applicable to a case of transmitting a packet from the access point to the wireless terminal. That is, the access point may calculate the CRC value by the same method as that of the wireless terminal stated above and create a packet, and the wireless terminal may calculate the CRC value by the same method as that of the access point stated above and perform authentication for each packet. By doing so, the wireless terminal can perform authentication for each packet and determine whether the packet is a packet from the third party pretending to be an access point or a legal packet from the access point.

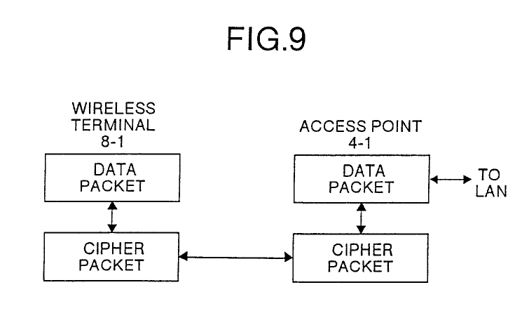

Next, description will be given to a case where the session shared key K is used for privacy. FIG. 9 is an explanatory view for describing a privacy processing in this embodiment. Here, description will be given while taking the communication between the wireless terminal 8-1 and the access point 4-1 as an example. In this privacy processing, when the wireless terminal transmits a data packet to the access point 4-1, the data packet is enciphered and transmitted by using the session shared key K held by the wireless terminal itself. The access point 4-1 which receives the enciphered cipher packet decodes the cipher packet using the session shared key K held by the access point itself and transmits the decoded packet to the destination.

Also, when the access point transmits the data packet to the wireless terminal 8-1, the access point enciphers the data packet using the session shared key K held by the access point itself and transmits the enciphered packet to the wireless terminal 8-1. The wireless terminal 8-1 which receives the encrypted cipher packet decodes the cipher packet using the session shared key K held by the wireless terminal itself. In this way, it is possible to keep information secret and to hold appropriate communication even in the communication between the access point 4-1 and the wireless terminal 8-1 over the wireless over which an illegal third party can easily conduct wire tapping and transmission of the communication.

As already described above, in this embodiment, the public key Y_{A} used for the creation of the session shared key K is inserted into the packet transmitted from the wireless terminal to the access point based on the DHCP, the public key Y_{B} used for the creation of the session shared key K is inserted into the packet transmitted from the access point to the wireless terminal based on the DHCP, the session shared key K is created based on the public key Y_{A} on the access point side and the session shared key K is created based on the public key Y_{B} on the wireless terminal side.

By doing so, it is possible exchange the public keys Y_{A} and Y_{B} without increasing the number of times of packet exchange when the communication between the wireless terminal and the access point is started. Due to this, the session shared key K for privacy and/or authentication can be safely shared between the wireless terminal and the access point while suppressing the delay of the establishment of the communication between the wireless terminal and the access point. In addition, description has been given in this embodiment while taking the DHCP as an example. The other protocol such as an ARP (Address Resolution Protocol) executed prior to the communication between the wireless terminal and the access point may be used. In the latter case, a processing section for carrying out a processing relating to the protocol is provided in place of each DHCP processing section stated above. Also, the session shared key may be replaced by a pair of the secret key and the public key. Besides, while the prime p is employed in the above-stated embodiment, the exponentiation of the prime may be employed. Also, the Diffie-Helman type public key delivery method using the elliptical curve cryptosystem may be employed.

As stated so far, according to the session shared key sharing method of one aspect of the present invention, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

Moreover, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

Furthermore, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

Moreover, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

Furthermore, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

According to the wireless terminal authentication method of another aspect of the present invention, it is possible to safely share the session shared key for authenticating the wireless terminal between the wireless terminal and base station device without increasing the number of times of packet exchange when the wireless terminal and the base station device start communicating with each other. In other words, it is possible to reduce illegal access to the network while suppressing delay until the communication between the wireless terminal and the base station device is established.

Moreover, it is possible to safely share the session shared key for authenticating the wireless terminal between the wireless terminal and base station device without increasing the number of times of packet exchange when the wireless terminal and the base station device start communicating with each other. In other words, it is possible to reduce illegal access to the network while suppressing delay until the communication between the wireless terminal and the base station device is established.

Furthermore, it is possible to safely share the session shared key for authenticating the wireless terminal between the wireless terminal and base station device without increasing the number of times of packet exchange when the wireless terminal and the base station device start communicating with each other. In other words, it is, possible to reduce illegal access to the network while suppressing delay until the communication between the wireless terminal and the base station device is established.

Moreover, it is possible to safely share the session shared key for authenticating the wireless terminal between the wireless terminal and base station device without increasing the number of times of packet exchange when the wireless terminal and the base station device start communicating with each other. In other words, it is possible to reduce illegal access to the network while suppressing delay until the communication between the wireless terminal and the base station device is established.

Furthermore, it is possible to safely share the session shared key for authenticating the wireless terminal between the wireless terminal and base station device without increasing the number of times of packet exchange when the wireless terminal and the base station device start communicating with each other. In other words, it is, possible to reduce illegal access to the network while suppressing delay until the communication between the wireless terminal and the base station device is established.

Furthermore, it is possible to protect the session shared key further appropriately.

Moreover, it is possible to authenticate the wireless terminal for each packet without changing a packet format and it is, therefore, possible to reduce illegal access to the network further appropriately.

According to the wireless terminal of still another aspect of the present invention, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

According to the wireless terminal of still another aspect of the present invention, it is possible to safely share the session shared key for authenticating the wireless terminal between the wireless terminal and base station device without increasing the number of times of packet exchange when the wireless terminal and the base station device start communicating with each other. In other words, it is possible to reduce illegal access to the network while suppressing delay until the communication between the wireless terminal and the base station device is established.

Moreover, it is possible to authenticate the wireless terminal for each packet without changing a packet format and it is, therefore, possible to reduce illegal access to the network further appropriately.

According to the base station device of still another aspect of the present invention, it is possible to exchange information for creating the session shared key without increasing the number of times of packet exchange when the wireless terminal and the base station device start communicating with each other. In other words, it is possible to safely share the session shared key for privacy and/authentication between the wireless terminal and base station device while suppressing delay until the communication between the wireless terminal and the base station device is established.

According to the base station device of still another aspect of the present invention, it is possible to safely share the session shared key for authenticating the wireless terminal between the wireless terminal and base station device without increasing the number of times of packet exchange when the wireless terminal and the base station device start communicating with each other. In other words, it is possible to reduce illegal access to the network while suppressing delay until the communication between the wireless terminal and the base station device is established.

Moreover, it is possible to authenticate the wireless terminal for each packet without changing a packet format and it is, therefore, possible to reduce illegal access to the network further appropriately.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A session shared key sharing method of sharing a session shared key for privacy and/or authentication between a wireless terminal that transmits and receives a packet and a base station device that relays the packet when said wireless terminal and said base station device communicate with each other over wireless, the method comprising:
a first insertion step of inserting first information used for creating the session shared key into the packet transmitted from said wireless terminal to said base station device based on a protocol executed when said wireless terminal and said base station device start communicating with each other;
a second insertion step of inserting second information used for creating the session shared key into the packet transmitted from said base station device to said wireless terminal based on the protocol;
a first creation step of allowing said base station device to create the session shared key based on the first information inserted in the first insertion step; and
a second creation step of allowing said wireless terminal side to create the session shared key based on the second information inserted in the second insertion step.

2. The session shared key sharing method according to claim 1, wherein the protocol is a protocol for making a network layer address correspond to an MAC address.

3. The session shared key sharing method according to claim 1, wherein the protocol is an ARP, the ARP being short for Address Resolution Protocol.

4. The session shared key sharing method according to claim 1, wherein the protocol is a protocol for allocating a network layer address to said wireless terminal.

5. The session shared key sharing method according to claim 1, wherein the protocol is a DHCP, the DHCP being short for Dynamic Host Configuration Protocol.

6. A wireless terminal authentication method of authenticating a wireless terminal that transmits and receives a packet relayed by a base station device when said wireless terminal and said base station device communicate with each other over wireless, the method comprising:
an encryption step of enciphering first information for creating a session shared key used for the authentication using a secret key;
a first insertion step of inserting the first information enciphered in the encryption step into the packet transmitted from said wireless terminal to said base station device based on a protocol executed when said wireless terminal and said base station device start communicating with each other;
a decoding step of allowing said base station device to transmit the enciphered first information inserted in the first insertion step to an authentication station decoding and resending information enciphered using the secret key, and to receive the first information decoded by the authentication station;
a second insertion step of inserting second information used for creating the session shared key into the packet transmitted from said base station device to said wireless terminal based on the protocol;
a first creation step of allowing said base station device to create the session shared key based on the first information decoded in the decoding step; and
a second creation step of allowing said wireless terminal to create the session shared key based on the second information inserted in the second insertion step.

7. The wireless terminal authentication method according to claim 6, wherein the protocol is a protocol for making a network layer address correspond to an MAC address.

8. The wireless terminal authentication method according to claim 6, wherein the protocol is an Address Resolution Protocol.

9. The wireless terminal authentication method according to claim 6, wherein the protocol is a protocol for allocating a network layer address to said wireless terminal.

10. The wireless terminal authentication method according to claim 6, wherein the protocol is a Dynamic Host Configuration Protocol.

11. The wireless terminal authentication method according to claim 6, wherein the first information and the second information are public keys based on a Diffie-Helman type public key delivery method; and
the session shared key is a shared key based on the Diffie-Helman type public key delivery method.

12. The wireless terminal authentication method according to claim 6, further comprising:
a first hash value calculation step of calculating a hash value based on data including a data link layer payload of the packet transmitted from said wireless terminal to said base station device and the session shared key created in the second creation step;
a first CRC value calculation step of calculating a CRC value based on data including an MAC header and the payload of the packet and the hash value calculated in the first hash value calculation step;
a packet transmission step of transmitting the packet with the CRC value calculated in the first CRC value calculation step being added to the MAC header and the payload of the packet, from said wireless terminal to said base station device;
a second hash value calculation step of allowing said base station device to calculate a hash value based on data including the MAC header and the payload transmitted in the packet transmission step and the session shared key created in the first creation step;
a second CRC value calculation step of calculating a CRC value based on data including the MAC header and the payload transmitted in the packet transmission step and the hash value calculated in the second hash value calculation step; and
an authentication step of allowing said base station device to authenticate said wireless terminal for each packet by comparing the CRC value transmitted in the packet transmission step with the CRC value calculated in the second CRC value calculation step.

13. A wireless terminal for communicating with a base station device for relaying a packet over wireless, comprising:
an insertion unit which inserts first information used for creating a session shared key for privacy and/or authentication into the packet transmitted to said base station device based on a protocol executed when the wireless terminal starts communicating with said base station device;
an acquisition unit which acquires second information included in the packet transmitted from said base station device based on the protocol and used for creating the session shared key; and
a creation unit which creates the session shared key based on the second information acquired by said acquisition unit.

14. A wireless terminal for communicating with a base station device for relaying a packet, comprising:
an encryption unit which enciphers first information used for creating a session shared key for authenticating said wireless terminal using a secret key;
an insertion unit which inserts the first information enciphered by said encryption unit into the packet transmitted to said base station device based on a protocol executed when the wireless terminal starts communicating with said base station device;
an acquisition unit which acquires second information included in the packet transmitted from said base station device based on the protocol and used for creating the session shared key; and
a creation unit which creating the session shared key based on the second information acquired by said acquisition unit.

15. The wireless terminal according to claim 14, further comprising:
a hash value calculation unit which calculates a hash value based on data including a data link layer payload of the packet transmitted to said base station device and the session shared key created by said creation unit;
a CRC value calculation unit which calculates a CRC value based on data including an MAC header and the payload of the packet and the hash value calculated by said hash value calculation unit; and
a packet transmission unit which transmits the packet, with the CRC value calculated by said CRC calculation unit being added to the MAC header and the payload, to said base station device.

16. A base station device for relaying a packet transmitted and received by a wireless terminal, comprising:
an acquisition unit which acquires first information included in the packet transmitted from said wireless terminal based on a protocol executed when said base station device starts communicating with said wireless terminal, the first information used for creating a session shared key for privacy and/or authentication;
an insertion unit which inserts second information used for creating the session shared key into the packet transmitted to said wireless terminal based on the protocol; and
a creation unit which creates the session shared key based on the first information acquired by said acquisition unit.

17. Abase station device for relaying a packet transmitted and received by a wireless terminal, comprising:
an acquisition unit which acquires first information included in a packet transmitted from said wireless terminal based on a protocol executed when the base station device starts communicating with said wireless terminal, the first information enciphered by a secret key and used for creating a session shared key for authenticating said wireless terminal;
a decoding unit which transmits said enciphered first information acquired by said acquisition unit to an authentication station decoding and resending information enciphered by the secret key, and for receiving the first information decoded by the authentication station;
an insertion unit which inserts second information used for creating the session shared key into the packet transmitted to said wireless terminal based on the protocol; and
a creation unit which creates the session shared key based on the first information received by said decoding unit.

18. The base station device according to claim 17, further comprising:
a hash value calculation unit which calculates a hash value based on data including a data link layer payload of the packet received from said wireless terminal and the session shared key created by said creation unit;
a CRC value calculation unit which calculates a CRC value based on data including an MAC header and the payload of the packet and the hash value calculated by said hash value calculation unit; and
an authentication unit which authenticates said wireless terminal for each packet by comparing a CRC value of the packet received from said wireless terminal with the CRC value calculated by said CRC value calculation unit.
